(19) United States
(12) Patent Application Publication
(10) Pub. No.: US 2003/0211285 A1
(43) Pub. Date: Nov. 13, 2003

(54) Image-displaying sheet and production method of image-displaying sheet

(76) Inventor: Hidetoshi Abe, Tendo-city (JP)

Correspondence Address: 3M INNOVATIVE PROPERTIES COMPANY, PO BOX 33427, ST. PAUL, MN, 55133-3427, US

(21) Appl. No.: 10/296,693

(22) PCT Filed: Jun. 27, 2001
(86) PCT No.: PCT/US01/20499

(30) Foreign Application Priority Data
Jun. 30, 2000 (JP) 2000-198055

(51) Int. Cl. B32B 31/00

(52) U.S. Cl. 428/138; 156/253

(57) ABSTRACT

With an image-displaying sheet comprising an imaging layer having a plurality of through holes, and a transparent adhesive film, the surface of which is fixed to said imaging layer, and the back surface of which is used to bond said imaging layer to a transparent adherent, in which the imaging layer comprises a shielding film having the first dark shielding layer and the second white shielding layer, and an image-forming Layer the surface of which is fixed to the back surface of said second shielding layer, the shielding effects of a shielding film are increased by the increase of the thickness of the first and second shielding layer, and at the same time, the whiteness of the second shielding layer is increased. In the above image-displaying sheet, the thickness of the first shielding layer is in a range between 15 and 100 μm, and the thickness of said second shielding layer is in a range between 20 to 100 μm, the adhesive film comprises the first transparent adhesive layer which is adhered to said imaging layer, and the second transparent adhesive layer which is used to bond the imaging layer to the adherent, and the adhesive film has no through hole which communicates with any of the through holes of the imaging layer.

### BACKGROUND OF THE INVENTION

1. Field of the Invention

The present invention relates to an image-displaying sheet and a method for the production of the same. In particular, the present invention relates to the improvement of an image-displaying sheet which can be adhered to the surface or the back surface of a transparent adherent such as a pane of buildings or vehicles (e.g. automobiles, airplanes, etc.) using a transparent adhesive film, and which allows viewers to read the image of the image-displaying sheet from the back surface side of the adherent (for example, outside of rooms or vehicles) and also allows other viewers to see the outside scenery behind the adherent from the surface side of the adherent (for example, inside of the rooms or vehicles) through the image-displaying sheet.

2. Description of the Related Art

An image-displaying sheet is known, which is adhered to a transparent adherent such as a pane, and allows the outside viewers to see the image, and allows the inside viewers to see the scenery outside the pane.

The image-displaying sheet usually has designs, characters, signs, etc., and is adhered to an adherent for the purpose of decoration or advertisement.

As described above, it is preferable for inside viewers to see the outside conditions, since the adherent is often the pane of the building or vehicle. Thus, a plurality of through holes are formed in the shielding film and the image-forming layer (which forms a visible image such as the above design, etc.) of the image-displaying sheet, and therefore, the conditions behind the adherent can be seen through such through holes.

Examples of such image-displaying sheets which are commercially available include Oneway Vision® (available from Sumitomo-3M), Contravision® (available from TOPPAN PRINGING CO., LTD.), etc.

The structures and production methods of the conventional image-displaying sheets are disclosed in, for example, JP-B-5-3721, Japanese Patent Publication No. 2,617,393, etc.

Now, the conventional image-displaying sheet is explained.

The conventional image-displaying sheet comprises (A) an imaging layer having a plurality of through holes, and (B) a transparent adhesive layer the surface of which is fixed to the imaging layer, and the back surface of which is used to bond the imaging layer to a transparent adherent. The imaging layer comprises (I) a shielding film (which may be referred to as “blocking-out film”) having (I-1) the first dark shielding layer and (I-2) the second white shielding layer the surface of which is fixed to the back surface of the first shielding layer, and (II) an image-forming layer the surface of which is fixed to the back surface of the second shielding layer. As explained below, the adhesive layer usually has through holes which communicate with the through holes of the imaging layer, since the imaging layer and the adhesive layer are integrated when the through holes are formed in the imaging layer.

Such an image-displaying sheet is adhered to an adherent such as a pane through the adhesive layer. In general, the image-displaying sheet is adhered to the surface of the adherent such as a pane on the interior side of the adherent. Unless otherwise described, when a pane is used as an example of an adherent, a surface of the pane on the interior side of a room or a vehicle is named “surface”, while that on the exterior side of the room or the vehicle is named “back surface”.

The shielding film of the image-displaying sheet has the first dark shielding layer, and the second white shielding layer the surface of which is fixed to the back surface of the first shielding layer. Due to the function of the shielding film, the image may not be seen from the surface side of the adherent (that is, the interior of the room or the vehicle in the case of the pane). On the other hand, the visibility of the image such as coloring or brightness should be increased, when the image is seen from the back surface side of the adherent (that is, the exterior of the room or the vehicle) Therefore, it is preferable to increase the shielding effects of the shielding film, and also to effectively increase the whiteness of the second shielding layer, which functions as a grounding of the image to be seen from the back surface of the adherent, so that the image can be seen brightly without the influence of the dark color of the first shielding layer. To this end, the first shielding layer is made as thick as possible, and also the second shielding layer is made as thick as possible. In the conventional image-displaying sheet, the total thickness of the shielding film is at most 10 to 15 μm.

However, when the thickness of each shielding layer is increased as much as possible, the conventional production method may suffer from the following problems.

In the conventional method, in general, a lamination having a transparent film as a precursor of a shielding film, an adhesive layer and a liner to protect the adhesive layer is provided, and then perforated to produce the laminate having through holes. After perforating, the first and second shielding layers are formed by printing such as silk screen printing on the surface of the transparent film (the precursor of the shielding film) to form the perforated shielding film having the adhesive layer. Subsequently, an image-forming layer, which displays an image, is formed on the shielding film by printing.

When the shielding layers and the image-forming layer are provided, the through holes should not be occluded. Thus, it is difficult to employ a method which forms a relatively thick coating layer such as a coating method of a paint. Accordingly, it is difficult to increase the thickness of the shielding film as much as possible while avoiding the occlusion of the through holes by this method.

Alternatively, it may be contemplated to perforate the laminate after forming the laminate having the thicker shielding layers. However, when the thickness of the shielding layers is increased, the thickness of the laminate increases unless the liner is made thin, and thus the perforation of the laminate may become difficult.

Furthermore, usually, an adhesive having relatively high flowability such as a pressure-sensitive adhesive is used to form the adhesive layer. Thus, the pressure-sensitive adhesive tends to penetrate into the through holes, or it passes through the holes to exude on the surface of the laminate, in the course of perforation. For such reasons, the perforation of the laminate which inevitably has the adhesive layer and the liner should be carried out with the special attentions in some cases.

### SUMMARY OF THE INVENTION

The objects of the present invention are to provide an image-displaying sheet which achieves the easy increase of the thickness of the first and second shielding layers of the shielding film and the effective increase of the shielding properties of the shielding film, and at the same time allows the effective increase of the whiteness of the second shielding layer, and also a method for producing such an image-displaying sheet.

To solve the above problems, the present invention provides an image-displaying sheet comprising

(1) an imaging layer having a plurality of through holes, and

(2) a transparent adhesive film, the surface of which is fixed to said imaging layer, and the back surface of which is used to bond said imaging layer to a transparent adherent,

wherein said imaging layer comprises

a shielding film having

(a-1) the first dark shielding layer,

(a-2) the second white shielding layer the surface of which is fixed to the back surface of said first shielding layer, and

(b) an image-forming layer the surface of which is fixed to the back surface of said second shielding layer, characterized in that the thickness of said first shielding layer is in a range between 15 and 100 μm, and the thickness of said second shielding layer is in a range between 20 to 100 μm,

said adhesive film comprises the first transparent adhesive layer which is adhered to said imaging layer, and the second transparent adhesive layer which is used to bond said imaging layer to the adherent, and

said adhesive film has no through hole which communicates with any of the through holes of said imaging layer, and

a method for producing the image-displaying sheet of claim 1 comprising the steps of:

(i) providing a precursor of the first shielding layer, and laminating a precursor of the second shielding layer on said precursor of the first shielding layer to form a precursor of the shielding film,

(ii) perforating said precursor of the shielding film to form through holes to complete said shielding film,

(iii) forming said image-forming layer by adhering a coloring material on the back surface of said second shielding layer of said shielding film without occluding said through holes, to provide said imaging layer, and

(iv) separately, providing said adhesive film, and fixing said imaging layer and said adhesive film each other to form the image-displaying sheet.

### BRIEF DESCRIPTION OF THE DRAWINGS

FIG. 1 is a side view of one preferred embodiment of the interior adhesion type image-displaying sheet according to the present invention.

FIG. 2 is a side view of one preferred embodiment of the exterior adhesion type image-displaying sheet according to the present invention.

FIG. 3 is a side view of the image-displaying sheet produced by the preferred production method according to the present invention.

FIG. 4 is a side view of the precursor of the imaging layer carrying the temporary support produced by the preferred production method according to the present invention.

### DETAILED DESCRIPTION OF THE PREFERRED EMBODIMENTS

According to the present invention, the adhesive layer and the liner are not laminated on the shielding film, when the shielding film is perforated. Therefore, the first and second shielding layers can be easily formed a coating layer or a colored resin film having a relatively large thickness

The image-displaying sheet of the present invention can be produced by perforating the imaging layer comprising the shielding film and the image-forming layer to form through holes extending in the thickness direction through all the thickness of the imaging layer, and fixing the imaging layer and an adhesive film which is separately provided in place of the conventional adhesive layer. Furthermore, it may be possible to perforate the shielding film only. Thus, it is very easy to increase the overall thickness of the shielding film and improve the shielding properties.

The adhesive film should have relatively high stiffness for the following reason:

In the image-displaying sheet of the present invention, the adhesive film, which functions as an adhesive layer to bond the imaging layer to the adherent, has no through hole which communicates with the through holes of the imaging layer, unlike the structure of the conventional image-displaying sheet. Furthermore, the image-displaying sheet is adhered to the adherent by placing the image-displaying sheet on the adhering surface of the adherent, and pressing the image-displaying sheet against the adhering surface. In such a case, the adhesive film is pressed against the adhering surface with a sufficient force in areas having no through holes, while the adhesive film is not sufficiently pressed against the adhering surface in areas having the through holes so that the adhesion force on the adhering surface may be less uniform. The non-uniformity of the adhesion force makes it difficult to strongly bond the image-displaying sheet to the adherent. When the adhesive film has adequate stiffness, it can be sufficiently press adhered to the adherent and thus the image-displaying sheet can be firmly adhered to the adherent.

The above-described effects of the adhesive sheet may be attained when the adhesive film having a plurality of adherent layers and interlayer interfaces instead of the adhesive sheet having a single layer structure is used. The presence of the interface between the adhesive layers can allow the adhesive film to be sufficiently pressed to the adherent even in the areas having the through holes, and therefore the image-displaying sheet can be easily adhered to the adherent with good adhesion strength.

The functions of the interface between the adhesive layers have not been clarified in detail, but may be assumed that, in the above adhering procedures, the pressure applied to the imaging layer may be diffused along the interface between the adhesive layers so that the adhesion force on the adhering surface can be effectively uniform.

As described above, the adhesive film preferably comprises two adhesive layers, that is, the first transparent adhesive layer adhered to the imaging layer and the transparent second layer with which the imaging layer is adhered to the adherent.

The adhesive film used in the present invention is usually

(1) a laminated adhesion film having two adhesive layers, one of which is a self-supporting adhesive, that is, a film adhesive, or

(2) a double-coated adhesive film having (I) a transparent substrate, (II) the first adhesive layer fixed to the surface of the substrate, and (III) the second adhesive layer fixed to the back surface of the substrate.

From the viewpoint of the easiness of the adhesion of the image-displaying sheet, the double-coated adhesive (2) is preferable. To increase heat resistance and durability, the first adhesive layer preferably contains a heat-sensitive adhesive comprising a crosslinked tacky polymer.

The adhesive film will be explained in detail later.

Although the details will be explained later, transparent materials (an adherent, adhesive layers, a substrate, a covering layer, etc.) are used in the image-displaying sheet, and for the production of the image-displaying sheet. Herein, the term “transparent” means that a material is sufficiently light transmitting to achieve the effects of the present invention. In general, the light transmittance is at least 75%, preferably at least 80%, and more preferably at least 85%. The light transmittance herein used is a diffusive transmittance measured using a spectrophotometer.

Image-Displaying Sheet

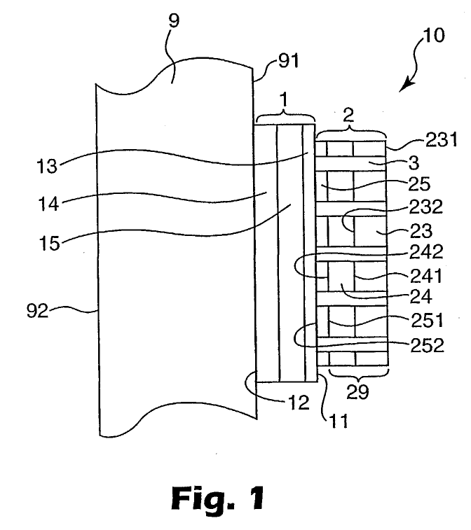

One preferable example of the image-displaying sheet of the present invention will be explained by making reference to FIG. 1.

FIG. 1 shows the image-displaying sheet (10) which is adhered to the surface (91) of the pane (9) as an adherent.

In FIG. 1, the image-displaying sheet (10) comprises the imaging layer (2) having a plurality of through holes (3), and the transparent adhesive film (1) the surface (11) of which is fixed to the imaging layer (2), and the back surface (12) of which bonds the imaging layer (2) to the pane (9) as the adherent.

The imaging layer (2) comprises

(a) the shielding film (29) having the first dark shielding layer (23), and the second white shielding layer (24) the surface (241) of which is fixed to the back surface (232) of the first shielding layer (23), and

(b) the image-forming layer (25) the surface (251) of which is fixed to the back surface (242) of the second shielding layer (24).

The adhesive layer (1) comprises the first transparent adhesive layer (13) which is adhered to the imaging layer (2), and the second transparent adhesive layer (14) which bonds the imaging layer (2) to the adherent (9).

The adhesive film (1) is characterized in that it has no hole which communicates with any through hole (3) of the imaging layer.

In the image-displaying sheet of FIG. 1, the adhesive film (1) has the transparent substrate (15), and thus it is the above-described double-coated adhesive film.

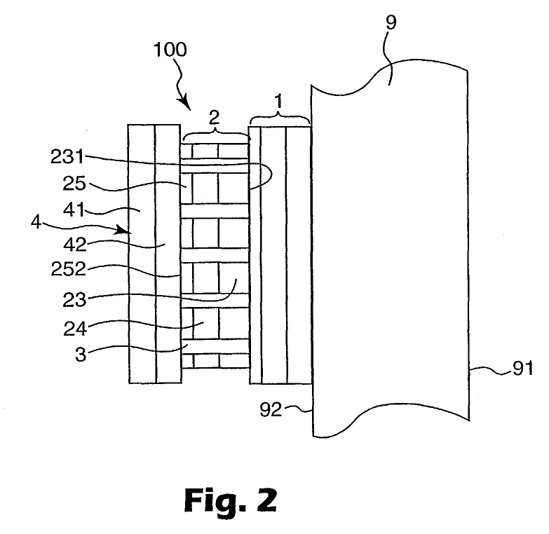

In the embodiment of FIG. 1, the image-displaying sheet (10) is adhered to the inside surface of the pane, that is, the surface (91). Such a case may be called “interior adhesion” (or indoor adhesion). In the embodiment of FIG. 2, the image-displaying sheet (100) is adhered to the outside surface of the pane, that is, the back surface (92). This case may be called “exterior adhesion” (or outdoor adhesion).

The interior adhesion type image-displaying sheet (10) and the exterior adhesion type image-displaying sheet (100) are substantially the same except for the following points:

In the case of the interior adhesion type one (10), the adhesive film (1) is adhered and fixed to the image-forming layer (25) of the imaging layer (2), while in the case of the exterior adhesion type one (100), the adhesion film (1) is adhered and fixed to the first shielding layer (23) of the imaging layer (2).

In the case of the exterior adhesion, it is preferable to increase the heat resistance and durability of the adhesive layers of the adhesive film. From such a viewpoint, at least the adhesive layer, which is used to bond the imaging layer and the adhesive film, preferably contains a heat-sensitive adhesive comprising a crosslinked tacky polymer.

Furthermore, in the case of the exterior adhesion type one (100), it preferably comprises the covering layer (4). If no covering layer is used, the through holes (3) communicate with the outside atmosphere, and foreign particles such as dust adhere to the surface (11) of the first adhesive layer (13) to occlude the through holes (3). Accordingly, the covering layer (4) is advantageous particularly for the exterior adhesion type image-displaying sheet of the present invention.

In the case of the exterior adhesion type one (100), the covering layer (4) is a transparent layer which shields the through holes (3), and is fixed to the surface of the imaging layer (2) opposite to the surface fixed to the adhesive layer, that is, the back surface (252) of the image-forming layer (25). In general, the covering layer (4) comprises the transparent film (41). In the embodiment of FIG. 2, the transparent film (41) is fixed to the imaging layer (2) through the transparent adhesive layer (42).

Of course, the interior adhesion type image-displaying sheet (10) may have such a covering layer (4).

In general, to apply the covering layer (4), the film (41) and the adhesive layer (42) are provided in the form of a covering film carrying a transparent adhesive, and then they are fixed to the imaging layer or the image-displaying sheet, which has been separately produced. In this case, the covering layer may be fixed to the image-displaying sheet before or after the image-displaying sheet is adhered to the adherent.

For the film (41), a polymer film can be used, for example, a film made of a polymer such as a vinyl chloride polymer (including a homopolymer and a copolymer), polyester, an ionomer, an acrylic polymer, polyurethane, an olefin polymer, etc. may be used.

The adhesive of the adhesive layer (42) may be a pressure-sensitive adhesive or a heat-sensitive adhesive.

The thickness of the film (41) is usually from 5 to 600 μm, preferably from 10 to 50 μm.

The thickness of the film (42) is usually from 10 to 500 μm, preferably from 15 to 400 μm.

In the case of the exterior adhesion type image-displaying sheet, the image-forming layer can be seen through no glass. Thus, the visibility does not deteriorate, even under view conditions where the halation on the glass surface is intense. From such a viewpoint, the exterior adhesion type one is more preferable than the interior adhesion type one.

Shielding Film

The first shielding layer of the shielding film is formed from a coated film of a coating composition containing a black colorant such as a black pigment, or a resin film containing a black colorant.

The second shielding layer of the shielding film is formed from a coated film of a coating composition containing a white colorant such as a white pigment, or a resin film containing a white colorant. The second shielding layer may contain other colorant in addition to the white colorant in a weight smaller than that of the white colorant, insofar as the effects of the present invention are not impaired. Furthermore, the second shielding layer may contain a pigment other than the white pigment (e.g. metalescent pigments) in a weight smaller than that of the white pigment.

As explained above, the image should not substantially be seen from the surface side of the adherent (indoor or interior of the room or the automobile), while the visibility of the image from the back surface side of the adherent (outdoor or exterior of the room or the automobile) should be increased. Thus, the shielding properties of the shielding film should be effectively increased, and at the same time, the whiteness of the second shielding layer should be effectively increased. From such a viewpoint, preferably, the thickness of the first shielding layer is in the range between 15 and 100 μm, and that of the second shielding layer is in the range between 20 to 100 μm.

When the thickness of the first shielding layer is too small, the shielding properties of the shielding film may not be effectively increased. When the thickness of the first shielding layer is too large, the perforation of the shielding film may not be facilitated. Furthermore, the whiteness of the second shielding lay may not be effectively increased depending on the thickness of the second shielding layer.

When the thickness of the second shielding layer is too small, the whiteness of the second shielding layer may not be effectively increased because of the influence of the darkness of the first shielding layer, and thus the shielding properties of the shielding film as a whole may not be effectively increased. When the thickness of the shielding layer is too large, the perforation of the shielding film may not be facilitated.

From the above viewpoints, the thickness of the first shielding layer is preferably from 20 to 80 μm, more preferably from 25 to 60 μm, and the thickness of the second shielding layer is preferably from 30 to 90 μm, more preferably from 40 to 80 μm.

The total thickness of the shielding film is usually from 35 to 200 μm, preferably from 50 to 170 μm, and more preferably from 70 to 140 μm.

The light transmittance of the first shielding layer is usually 15% or less, preferably 12% or less, and more preferably 10% or less, and the light transmittance of the second shielding layer is usually 25% or less, preferably 20% or less, and more preferably 15% or less.

Each shielding layer is preferably produced by preparing a coating composition comprising a colorant such as a pigment, a polymer and a solvent, and then forming a film from the composition. Examples of the polymer include conventional thermoplastic polymers such as vinyl chloride polymers (including homopolymers and copolymers), polyesters, ionomers, acrylic polymers, polyurethane, olefin polymers, etc. The solvent may be any of organic solvents or aqueous solvents.

The above coating composition may be prepared by a conventional method for the preparation of a coloring coating, and may be coated by a conventional coating method. Examples of the coating means include knife coaters, roll coaters, die coaters, bar coaters, etc. The coated composition is dried at a temperature from 60 to 180° C.

The coating composition may contain any additive such as a plasticizer, a curing agent, a UV stabilizer, a heat stabilizer, etc.

The laminate having the two shielding layers (the precursor of the shielding film) may be formed by forming one coated film on one surface of a temporary support having an easy-releasing surface, and then laminating the other coated film on one coated film. For example, the coating composition for the first shielding layer is applied onto the surface of the temporary support and dried, and then the coating composition for the second shielding layer is coated on the formed first shielding layer and dried. Thus, the second shielding layer is laminated on the first shielding layer. In this case, the image-forming layer can be formed on the second shielding layer without peeling off the temporary support. Alternatively, the shielding layers are separately formed, and then thermally laminated to obtain the precursor of the shielding film.

The diameter of each through hole of the imaging layer is usually from 0.5 to 8 mm, and preferably from 1 to 5 mm. The through holes of the imaging layer may be formed by any conventional perforation methods. For example, a mechanical punching machine may be used.

The ratio of the total area of the through hole openings to the whole surface area of the imaging layer may be determined as in the case of the conventional image-displaying sheet, and is usually from 20 to 60%, and preferably from 40 to 55.

Image-Forming Layer

In general, the image-forming layer comprises a printed layer formed with printing means. For example, the printed layer may be formed by a conventional method such as electrostatic printing, silk screen printing, etc. In the case of the electrostatic printing, an electrostatic printing-transfer method using an electrostatic printing system “SCOTCH PRINT SYSTEM® of 3M (USA) may be employed. In this method, an image consisting of a printed layer is formed on a temporary support, which is called a transfer medium, using printing toners as colorants, and a part of the image is transferred and adhered to the second shielding layer by heating under pressure to form the image-forming layer. The parts of the printed layer corresponding to the through holes of the shielding film are left on the temporary support, while other parts of the printed layer, which are in contact with the second shielding layer, are transferred to the second shielding layer.

When such a transfer method is used, the second shielding layer of the shielding film preferably contains a resin which is thermoplastic at the above heating temperature to facilitate the transfer of the printing toners. Examples of the thermoplastic resin include vinyl chloride polymers (including homopolymers and copolymers), polyester, ionomers, acrylic polymers, polyurethane, olefin polymers, etc.

The printing toner comprises a binder resin, for example, a mixture of a vinyl chloride-vinyl acetate copolymer and an acrylic resin, and a pigment dispersed in the binder resin.

Alternatively, the image-forming layer can be formed by a printing method such as silk screen printing. In this case, preferably, a process substrate is placed on the surface of the first shielding layer of the shielding film to shield the through holes, which have been formed as described above, and then the shielding film carrying the process substrate is set in the printing machine. The process substrate is removed after the completion of the printing but before the use of the image-displaying sheet. The above covering film may be used in place of the process substrate.

The thickness of the image-forming layer may be the same as that of the conventional image-forming layer, and is usually from 0.1 to 100 μm.

Adhesive film

The adhesive film has substantially no hole that communicates with any through hole of the imaging layer. Preferably, the adhesive film comprises (I) a transparent substrate, (II) the first adhesive layer fixed to the surface of the substrate, and (III) the second adhesive layer fixed to the back surface of the substrate.

The second adhesive layer is preferably a layer which is pressure-sensitive, that is, a pressure-sensitive adhesive layer, which can bond the image-displaying sheet to the adherent by pressing at a room temperature (about 25° C.) without heating. Thus, the adhering procedure of the image-displaying sheet to the adherent is facilitated.

As the substrate, a polymer film, or a mesh sheet such as a scrim may be used. The thickness of the substrate is usually from 1 to 1,000 μm. Examples of the polymer include vinyl chloride polymers, polyester, ionomers, acrylic polymers, polyurethane, olefin polymers, etc.

The thickness of the first adhesive layer is usually from 5 to 100 μm, preferably from 8 to 50 μm, more preferably from 10 to 30 μm.

When the thickness of the adhesive layer is too small, the adhesion properties may deteriorate. When the thickness of the adhesive layer is too large, the transparency of the adhesive film may decrease depending on the light transmittance of the adhesives. The decrease of the transparency of the adhesive film will deteriorate the visibility of the image-forming layer which is seen through the adhesive film in the case of the interior adhesion type. On the other hand, in the case of the exterior adhesion type, the outside scenery behind the adherent can be easily seen when the color of the first shielding layer is black or dark color. Accordingly, it is preferable that the transparency of the adhesive film is not decreased, while the degree of the darkness of the first shielding layer is not decreased so that the outside scenery can be easily seen.

From the same viewpoint as above, the thickness of the second adhesive layer is usually from 5 to 100 μm, preferably from 8 to 50 μm, more preferably from 10 to 30 μm.

When the adhesive layer comprises a tacky polymer and a thermoplastic polymer as described below, the thickness of the adhesive layer is usually from 5 to 30 μm, and preferably from 10 to 20 μm, since the transparency tends to easily deteriorate.

Adhesive

As the adhesive used in the first adhesive layer, for example, a heat-sensitive adhesive and a pressure-sensitive adhesive may be used.

The heat-sensitive adhesive is an adhesive, the adhesion properties of which are enhanced by heating, and is also called a heat-active adhesive or a thermally press adhesive. Furthermore, the film of the heat sensitive adhesive may be used as the heat-sensitive adhesive. The heat-sensitive adhesive has low adhesion properties at room temperature, but it exhibits high adhesion properties on heating. Thus, it can fix the imaging layer and the adhesive film together with the high adhesion force on heating and pressing.

In general, the heat-sensitive adhesive comprises a composition containing a thermoplastic polymer. In addition, a mixture of a thermoplastic polymer and a tacky polymer may be used, insofar as the transparency does not deteriorate.

The tacky polymer may be crosslinkable, or the heat-sensitive adhesive may contain a crosslinking agent. The thermoplastic polymer may be polyester, polyurethane, polyamide, polyolefin, etc.

As the heat-sensitive adhesive, an adhesive comprising a heat-active adhesive composition, such is disclosed in JP-A-2000-119624, may be used.

The heat-active adhesive composition of this JP-A publication is a mixture of a polyester as a thermoplastic polymer, and a tacky polymer having (a) a hydroxyl group and (b) a phenyl group in the molecule. Preferably, the tacky polymer in this heat-sensitive adhesive comprising such a mixture has a crosslinkable functional group in addition to the above functional groups (a) and (b) so that it is crosslinkable.

Hereinafter, the details of such a heat-sensitive adhesive are explained.

The tacky polymer having the hydroxyl group and the phenyl group in the molecule has high compatibility with polyester and advantageously increases the transparency of the adhesive layer. In addition, the tacky polymer exhibits high tackiness when the polyester is molten or softened on heating. Thus, it can fix the imaging layer and the adhesive layer together with the high adhesion force by the thermally pressing process.

When the tacky polymer has a crosslinkable functional group reactive with the thermally crosslinking component (the functional group (c)) in the molecule, it can be thermally crosslinked with the addition of the thermally crosslinking component. Thus, the heat resistance and durability of the adhesive layer can be improved.

The crosslinkable functional group of the tacky polymer may be any functional group that is different from the hydroxyl group (a) and reactive with the thermally crosslinking component. Preferably, the crosslinkable functional group has either a carboxyl group or an epoxy group, or both. In the latter case, the thermally crosslinking component is selected so that it reacts with one of the carboxyl group and the epoxy group.

In such a case, the preferable thermally crosslinking component may be any compound having at least two crosslinkable functional groups reactive with the carboxyl group and/or epoxy group, which are the crosslinkable functional groups of the tacky polymer. Such a compound is usually a monomer or an oligomer.

Examples of the preferable combinations of the crosslinkable functional group of the tacky polymer and the thermally crosslinking component are as follows:

When the crosslinkable functional group is the carboxyl group, the thermally crosslinking component is preferably a bisamide base crosslinking component, or an epoxy resin.

When the crosslinkable functional group is the epoxy group, the thermally crosslinking component is preferably a rosin having a carboxyl group in the molecule (carboxylrosin).

When the crosslinkable functional group is either the carboxyl group or the epoxy group, it allows the thermal crosslinking without deteriorating the compatibility with the polyester, which is exerted by the hydroxyl group and phenyl group of the tacky polymer.

The tacky polymer will be explained further in detail.

Preferably, the polyester contained in the heat-sensitive adhesive is substantially non-tacky at room temperature (about 25° C.), and has such crystallinity that the polymer is molten on heating. The polyester is preferably polycaprolactone. Polycaprolactone is (i) polyester obtained by polymerizing a starting material containing caprolactone, or (ii) polyester comprising repeating units obtained from the ring-opening polymerization of caprolactone.

A composition comprising the tacky polymer and polycaprolactone has relatively small tackiness at room temperature because of the crystallization of polycaprolactone, but can exert strong adhesion force on heating since polycaprolactone melts.

When the tacky polymer having the hydroxyl group and the phenyl group in the molecule at the same time is an acrylic polymer, the compatibility of the acrylic polymer and polycaprolactone is particularly good.

The weight average molecular weight of the above polyester is usually from 1,000 to 100,000, preferably from 3,000 to 50,000, and more preferably from 4,000 to 20,000.

When the molecular weight is too low, the polyester may bleed out at the adhesion interface (between the adhesion surface of the adhesive layer and that of the adherent). When the polyester bleeds out at the adhesion interface, it solidifies or crystallizes at the interface, and tends to decrease the transparency of the adhesive layer including the adhesion interface.

When the molecular weight is too large, the compatibility of the polyester with the tacky polymer tends to decrease, and thus the transparency of the adhesive layer may decrease.

The percentage of the polyester in the whole heat-sensitive adhesive is usually 30 wt. % or less, preferably 25 wt. % or less, and more preferable from 5 to 15 wt. %. When the amount of the polyester is too high, the transparency of the adhesive layer may decrease, or the high adhesion force may not be attained just after the press adhering. When the amount of the polyester is too low, there arise no specific problem, but the mixture functions as a pressure-sensitive adhesive rather than the heat-sensitive adhesive.

For example, when the once adhered image-displaying sheet is peeled off from the adherent, the peeling is carried out while heating the image-displaying sheet. To facilitate the peeling of the image-displaying sheet, a suitable amount (preferably 5 wt. %) of the polyester is contained in the adhesive to enhance the heat sensitivity of the adhesive. When the adherent is glass, the adhesive layer containing an adequate amount (preferably from 2 to 30 wt. %) of the polyester and the above-explained tacky polymer acts as a pressure-sensitive adhesive layer.

Now, the details of the above tacky polymer are explained.

The tacky polymer may be obtained by polymerizing, as starting monomers, a monomer having a hydroxyl group in the molecule, and a monomer having a phenyl group in the molecule, and a monomer having an additional essential functional group in the molecule.

The tacky polymer will be explained by making reference to an acrylic polymer.

The acrylic polymer may be obtained by copolymerizing, as starting monomers, (A) one or more phenoxyalkyl acrylates, (B) a monomer having a hydroxyl group in the-molecule, (C) a monomer having a crosslinkable functional group, and (D) an alkyl acrylate having 3 to 10 carbon atoms in the alkyl group.

The polymerization method is, for example, solution polymerization, etc.

Examples of the monomer (A) include phenoxyethyl acrylate, phenoxypropyl acrylate, etc. Examples of the monomer (B) include 2-hydroxyethyl acrylate, 2-hydroxypropyl acrylate, 2-hydroxymethyl acrylate, 2-hydroxyethyl methacrylate, 2-hydroxypropyl methacrylate, hydroxy-3-phnenoxypropyl acrylate, etc. Examples of the monomer (C) include unsaturated acids such as acrylic acid, methacrylic acid, etc., and epoxy group-containing (meth)acryl monomer such as glycidyl (meth) acrylate. Examples of the monomer (D) include n-butyl acrylate, isobutyl acrylate, isooctyl acrylate, 2-ethylhexyl acrylate, etc.

The percentage of the repeating units having the essential functional groups (that is, the units derived from the monomers (A) and (B)) in the whole repeating units of the tacky polymer is usually from 40 to 99.9 wt. %, preferably from 50 to 95 wt. %.

The percentage of the repeating units derived from the monomer (B) in the whole repeating units of the tacky polymer is usually at least 0.5 mole %, and preferably from 1 to 25 mole %.

The percentage of the repeating units having the crosslinkable functional group (that is, the units derived from the monomer (C)) in the whole repeating units of the tacky polymer is usually from 0.1 to 15 wt. %, and preferably from 0.7 to 10 wt. %.

In addition to the polymer having the essential functional groups (the hydroxyl group and the phenyl group), the tacky polymer may contain a polymer having no essential functional groups. In such a case, the percentage of the polymer having the essential functional groups in the whole tacky polymer is usually at least 50 wt. %, and preferably at least 60 wt. %.

The molecular weight of the tacky polymer may be in the range in which the desired adhesion force is exerted, and is usually from 10,000 to 1,000,000 in terms of a weight average molecular weight.

A tackifier may be used in combination with the tacky polymer like the conventional pressure-sensitive adhesives. The percentage of the tacky polymer in the whole heat-sensitive adhesive is usually from 60 to 99 wt. %, preferably from 70 to 98 wt. %.

The heat-sensitive adhesive may be prepared by uniformly mixing the above components with conventional mixing procedures. For example, the tacky polymer, the polyester, the solvent and optional additives such as a crosslinking agent are mixed with a mixing machine such as a homomixer, a planetary mixer, etc. to dissolve or disperse the components uniformly. Thus, a liquid composition is obtained.

This liquid composition may be prepared in the form of a precursor solution containing the tacky polymer and the polyester which are uniformly dissolved by mixing the first solution containing the dissolved tacky polymer and the second solution containing the dissolved polyester. The obtained precursor solution is coated on the substrate and then dried to form the adhesive film having the adhesive layer comprising the heat-sensitive adhesive.

Examples of the coating means include a knife coater, a roll coater, a die coater, a bar coater, etc.

The drying to form the adhesive film is usually carried out at a temperature of 60 to 180° C. The drying time is usually from 30 seconds to 10 minutes.

The adhesive layer of the adhesive film may be a pressure-sensitive layer comprising a pressure-sensitive adhesive.

The pressure-sensitive adhesive may be a composition comprising the tacky polymer as a main component. The pressure-sensitive adhesive layer is an adhesive layer which can bond the sheet to the adherent by pressing the sheet against the adherent at room temperature (about 25° C.).

Examples of the tacky polymer in the pressure-sensitive adhesive include acrylic polymers, nitrile-butadiene copolymers (e.g. NBR, etc.), styrene-butadiene copolymers (e.g. SBR, etc.), polyurethane, silicone polymers, etc. Furthermore, the above-described tacky polymer having the hydroxyl group and the phenyl group in the molecule can be used. The tacky polymer is preferably crosslinked.

The tacky polymer in the pressure-sensitive adhesive may be a single polymer or a mixture of two or more polymers. In addition, a microsphere type adhesive, which contains a plurality of elastic microspheres, can be used as the pressure-sensitive adhesive.

A minute uneven structure may be formed on the adhesion surface of the second adhesive layer facing the adherent, that is, the back surface of the second adhesive layer.

Production of Image-Displaying Sheet

Although the image-displaying sheet of the present invention can be produced as already described, it is preferably produced by the method comprising the following steps:

(i) providing a precursor of the first shielding layer, and laminating a precursor of the second shielding layer on said precursor of the first shielding layer to form a precursor of the shielding film,

(ii) perforating said precursor of the shielding film to form through holes to complete said shielding film,

(iii) forming said image-forming layer by adhering a coloring material on the back surface of said second shielding layer of said shielding film without occluding said through holes, to provide said imaging layer, and

(iv) separately, providing said adhesive film, and fixing said imaging layer and said adhesive film each other to form the image-displaying sheet.

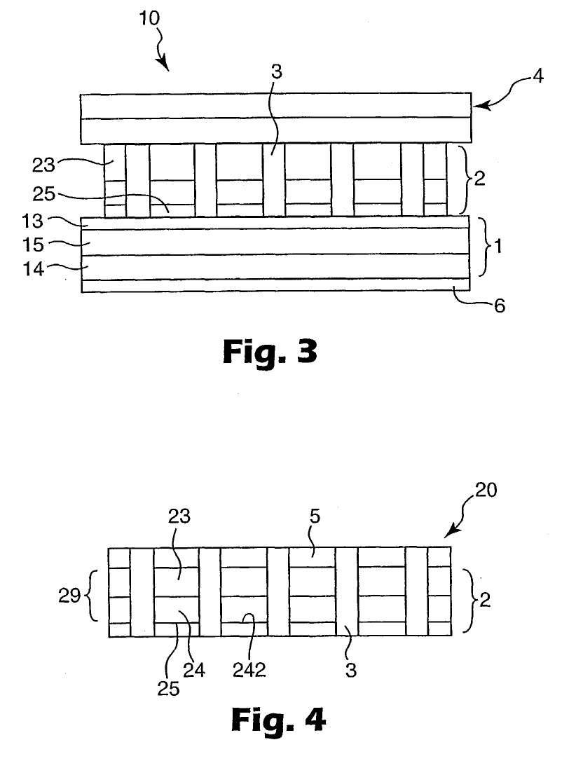

One embodiment of the image-displaying sheet, which is produced by the above preferable method, is explained by making reference to FIGS. 3 and 4.

In the above step (i), the precursor of the shielding film (that is, the unperforated shielding film (2)) is placed on the easy-releasing surface of the temporary support (5). The temporary support (5) may be a relatively soft substrate which can be easily perforated, for example, a polymer film such as a polyester film, or a release paper sheet, etc. The thickness of the temporary support is usually from 20 to 200 μm, and preferably from 30 to 150 μm.

In the next step (ii), a plurality of the through holes (3) are formed to obtain the shielding film (29) carrying the temporary support. Then, in the step (iii), the image-forming layer (25) is formed on the back surface (242) of the second shielding layer (24), for example, by transferring the printing toners. Thus, the imaging layer (20) carrying the temporary support is obtained, as shown in FIG. 4.

Separately, the adhesive film (1) is provided. The adhesive film (1) may be prepared by laminating the first adhesive layer (13) and the second adhesive layer (14) on the surface and back surface of the transparent substrate (15), respectively. Preferably, the precursor of the adhesive film, which comprises the substrate (15), the second adhesive layer (14) fixed to the back surface of the substrate, and the protective liner (6) which protects the adhesion surface of the second adhesive layer (14), is firstly provided, and then the first adhesive layer (13) is laminated on the surface of the substrate (15) to obtain the adhesive film carrying the liner.

Finally, the adhesive film (1) carrying the liner which is produced as described above, and the imaging layer (20) carrying the temporary support which is produced as described above are laminated to obtain the image-displaying sheet (10) having the structure of FIG. 3.

In the embodiment shown in FIG. 3, the first adhesive layer (13) of the adhesive film and the image-forming layer (25) of the imaging layer are adhered each other, since this is the interior adhesion type.

As already explained, when the exterior adhesion type is produced, the first adhesion layer (13) and the first shielding layer (23) of the imaging layer are adhered each other. In this case, the adhesive film (1) is laminated on the surface of the first shielding layer (23) after removing the temporary support (5).

In the embodiment of FIG. 3, the temporary support is already removed, and the covering layer (4) is adhered to the surface of the first shielding layer (23) of the imaging layer. When no covering layer is supplied, the temporary layer is not removed before the use of the image-displaying sheet, and it is removed after the image-displaying sheet is adhered to the adherent.

In the above-explained method, the step (iii) may be carried out as follows:

To form the image-forming layer, a laminate for transfer, which comprises the temporary support, the printed toner image, and the white layer, is prepared by a method for transferring the electrostatically printed toner image (an electrostatic printing-transfer method). The white layer is transferred to the second shielding layer of the shielding film and functions as the white shielding layer which assists the white-shielding effect of the second shielding layer. Accordingly, the thickness of the second shielding layer included in the precursor of the shielding film can be made relatively thin to facilitate the perforation of the shielding film, while the white shielding effect of the finished imaging layer can be easily improved.

The above laminate for transfer may be produced by providing the laminate of the temporary support and the printed toner image in the conventional electrostatic printing-transfer method, and forming the white layer on the surface of the printed toner image by a printing method such as screen printing.

The white layer may be made of the same material as that of the second shielding layer.

### EXAMPLES

### Example 1

An image-displaying sheet of this Example was produced by the above described production method. The details of the imaging layer and the adhesive film used in this Example are described below.

The image-displaying sheets produced in all Examples were exterior adhesion type ones as shown in FIG. 2.

Imaging Layer

Temporary support: A PET film having a thickness of 50 μm and an easy-releasing surface.

First shielding layer: A coated film having a thickness of 30 μm and containing a vinyl chloride polymer and a black pigment.

Second shielding layer: A coated film having a thickness of 50 μm and containing a vinyl chloride polymer and a white pigment.

Formation of through holes: using a conventional perforation machine.

Image-forming layer: Formed using the above-described “SCOTCH PRINT SYSTEM®” of 3M (USA).

Adhesive Film

Transparent substrate: A vinyl chloride polymer film having a thickness of 50 μm.

First shielding layer: A layer having a thickness of 17 μm and containing a heat-sensitive adhesive which has the following composition:

Tacky polymer:polycaprolactone: Bis-amide (crosslinking agent)=95:5:0.2 (weight ratio of non-volatile components).

Preparation of Adhesive

Firstly, a solution containing the tacky polymer (solvent: a mixture of 85 wt. % of ethyl acetate and 15 wt. % of methyl ethyl ketone; non-volatile content=30 wt. %), a solution of polycaprolactone in toluene (nonvolatile content=35 wt. %) and a thermally crosslinking component were mixed to prepare an adhesive solution. The adhesive solution was applied on the surface of the substrate and dried in an oven at 95° C. for 5 minutes to form the first adhesive layer having a thickness of 17 μm on the surface of the substrate.

Preparation of Tacky Polymer

The tacky polymer was a copolymer which was prepared by solution polymerizing the starting monomer mixture containing a monomer having a phenoxy group in the molecule (PEA: phenoxyethyl acrylate; BISCOAT® #192 manufactured by OSAKA ORGANIC CHEMICAL INDUSTRIES CO., LTD.) and a monomer having a phenoxy group and a hydroxyl group in the molecule (HPPA: 2-hydroxy-3-phenoxypropyl acrylate: ARONICS® M-5700 manufactured by TOAGOSEI CO., LTD.) as the essential monomers, and also the following additional monomers, in the above mixed solvent.

The composition of the tacky polymer was as follows:

PEA:HPPA:BA:AA=30:15:50:5 (by weight)

Additional components:

BA: n-Butyl acrylate (manufactured by TOAGOSEI CO., LTD.)

AA: Acrylic acid (manufactured by WAKO Pure Chemical Industries, Ltd.)

The polycaprolactone was manufactured by DAICEL CHEMICAL INDUSTRIES, LTD. (PRACCEL® HIP; molecular weight=about 10,000).

Second Adhesive Layer

Adhesive layer comprising a pressure-sensitive adhesive

The pressure-sensitive adhesive was AROSET® 8142 manufactured by NIPPON SHOKUBAI CO., LTD. A solution containing this adhesive was applied on the back surface of the substrate and dried in an oven at 95° C. for 5 minutes to form the second adhesive layer having a thickness of 30 μm on the back surface of the substrate.

Fixing Process of an Imaging Layer and an Adhesive Film

Lamination/fixing conditions: Heating temperature=100° C., pressure=50 psi (about 344 kPa)

Coating layer:

A transparent adhesive film Scotchcal® film SP 4582 (manufactured by 3M, USA) was used. This adhesive film comprises a transparent film of a vinyl chloride resin (thickness of 50 μm) and an adhesive layer containing an acrylic pressure-sensitive adhesive.

### Example 2

An image-displaying sheet of this Example was produced in the same manner as in Example 1 except that the first adhesive layer of the adhesive film was formed from the following thermoplastic polymer:

ACRYLOID® B82 manufactured by Rohm & Haas (USA). Thickness=17 μm.

### Example 3

An image-displaying sheet of this Example was produced in the same manner as in Example 1 except that the second adhesive layer was formed from the same heat-sensitive adhesive of the first adhesive layer, and an adhesive film for pane (Scotchtint® SH2CLL manufactured by 3M (USA)) was used as the covering layer.

The above adhesive film comprises a transparent PET film (thickness of 50 μm) and an adhesive layer containing an acrylic pressure-sensitive adhesive.

### Example 4

An image-displaying sheet of this Example was produced in the same manner as in Example 1 except that the thickness of the first shielding layer was changed from 30 μm to 25 μm, and thus the total thickness of the shielding film was decreased to 75 μm.

### Example 5

An image-displaying sheet of this Example was produced in the same manner as in Example 1 except that the thickness of the second shielding layer was changed from 50 μm to 40 μm, and thus the total thickness of the shielding film was decreased to 70 μm.

### Comparative Example 1

In this Comparative Example, a commercially sold image-displaying sheet, which was produced by the conventional method, was used. The thickness of the first shielding layer of this image-displaying sheet was 5 μm, and that of the second shielding layer was 6 μm.

### Comparative Example 2

An image-displaying sheet of this Comparative Example was produced in the same manner as in Example 1 except that the thickness of the first shielding layer was changed from 30 μm to 10 μm, the thickness of the second shielding layer was changed from 50 μm to 10 μm, and thus the total thickness of the shielding film was decreased to 20 μm.

The image-displaying sheets produced in the above Examples and Comparative Examples were evaluated as follows:

Coloring

The contrast of the image against the background (the white part of the second shielding layer), and the coloring of the image were visually observed. When a level was the same as that of the sheet produced in Example 1 with which the image was clearly seen, the sheet was ranked “O” (OK). When the image was inferior to that of Example 1, but the level was practically acceptable, the sheet was ranked Δ (Good). When the image was seen with difficulty, the sheet was ranked X (NG).

Shielding Property

The sheet was observed from the indoor side (from the side of the first shielding layer). When the image was shielded and could not be seen, the sheet was ranked O (OK). When the image was seen, the sheet was ranked X (NG).

Pressure Adhesion Properties

The image-displaying sheet was adhered to a pane as an adherent by pressing at room temperature (about 25° C.) without heating, and whether the sheet was adhered or not was checked.

When the sheet was easily adhered and could not be removed if no peeling process such as heating was used, the sheet was ranked O (OK). When the sheet was easily peeled off by hand in the absence of a peeling process such as heating, the sheet was ranked X (NG).

The results are shown in Table 1.

TABLE 1

| | | | |
|---|---|---|---|
| Evaluated | | Shielding | Pressure |
| property | Coloring | property | adhesion |

| | | | |
|---|---|---|---|
| Example 1 | ◯ | ◯ | ◯ |
| Example 2 | ◯ | ◯ | ◯ |
| Example 3 | ◯ | ◯ | ◯ |
| Example 4 | ◯ | ◯ | ◯ |
| Example 5 | ◯ | ◯ | ◯ |
| Comp. Ex. 1 | Δ | X | ◯ |
| Comp. Ex. 2 | Δ | X | ◯ |

From the above results, it was seen that the image-displaying sheets of the present invention have better shielding property than those of Comparative Examples, and the image (image-forming layer) formed on the back surface of the second shielding layer is beautifully colored with no influence of the dark color of the first shielding layer.

Reference Numerals

10, 100: Image-displaying sheet,

1: Adhesive film, 13: First adhesive layer, 14: Second adhesive layer, 1S: Substrate, 2, 20: Imaging layer, 23: First shielding layer, 24: Second shielding layer, 25: Image-forming layer, 29: Shielding film

3: Through holes,

4: Covering layer, 41: Transparent film, 42: Transparent adhesive layer,

5: Temporary support,

9: Pane

Further details of the invention are defined in the features of the claims.

It is claimed:

1. An image-displaying sheet comprising
(1) an imaging layer having a plurality of through holes, and
(2) a transparent adhesive film, the surface of which is fixed to said imaging layer, and the back surface of which is used to bond said imaging layer to a transparent adherent,
wherein said imaging layer comprises
a shielding film having
(a-1) the first dark shielding layer,
(a-2) the second white shielding layer the surface of which is fixed to the back surface of said first shielding layer, and
(b) an image-forming layer the surface of which is fixed to the back surface of said second shielding layer, characterized in that the thickness of said first shielding layer is in a range between 15 and 100 μm, and the thickness of said second shielding layer is in a range between 20 to 100 μm,
said adhesive film comprises the first transparent adhesive layer which is adhered to said imaging layer, and the second transparent adhesive layer which is used to bond said imaging layer to the adherent, and
said adhesive film has no through hole which communicates with any of the through holes of said imaging layer.

2. The image-displaying sheet according to claim 1, wherein said adhesive film is adhered and fixed to the first shielding layer of the imaging layer.

3. The image-displaying sheet according to claim 2, which further comprises a transparent covering layer which is fixed to the back surface of said image-forming layer and shields said through holes.

4. The image-displaying sheet according to claim 1, wherein said adhesive film comprises (I) a transparent substrate, (II) said first adhesive layer fixed to the surface of said substrate, and (III) said second adhesive layer fixed to the back surface of said substrate.

5. The image-displaying sheet according to claim 4, wherein said adhesive layer contains a heat-sensitive adhesive comprising a crosslinked tacky polymer.

6. A method for producing the image-displaying sheet of claim 1 comprising the steps of:
(i) providing a precursor of the first shielding layer, and laminating a precursor of the second shielding layer on said precursor of the first shielding layer to form a precursor of the shielding film,
(ii) perforating said precursor of the shielding film to form through holes to complete said shielding film,
(iii) forming said image-forming layer by adhering a coloring material on the back surface of said second shielding layer of said shielding film without occluding said through holes, to provide said imaging layer, and
(iv) separately, providing said adhesive film, and fixing said imaging layer and said adhesive film each other to form the image-displaying sheet.
